(19) United States
(12) Patent Application Publication
(10) Pub. No.: US 2014/0047957 A1
(43) Pub. Date: Feb. 20, 2014

(54) Robust Torque-Indicating Wrench

(71) Applicant: Jih Chun WU, Taichung City (TW)

(72) Inventor: Jih Chun WU, Taichung City (TW)

(21) Appl. No.: 13/587,922

(22) Filed: Aug. 17, 2012

(51) Int. Cl. B25B 23/142

(52) U.S. Cl. 81/467

(57) ABSTRACT

A torque-indicating wrench includes a handle, a strain gauge, a lever, a head and a driving mechanism. The strain gauge is placed in the handle. The lever including a first end inserted in and pivotally connected to the handle and abutted against the strain gauge and a second end placed out of the handle. The head includes a tubular portion non-pivotally placed around and on the handle. The driving mechanism includes a bit-rotating element pivotally placed in the head and formed with a crank pivotally connected to the second end of the lever.

### BACKGROUND OF INVENTION

1. Field of Invention

The present invention relates to a torque-indicating and, more particularly, to a robust torque-indicating wrench.

2. Related Prior Art

Referring to FIGS. 1 and 2, a conventional torque-indicating wrench includes a handle 10, a pivoting element 20, a selective one-way driving mechanism 30 and an elastic element 40. A strain gauge 15 is biased by a spring placed in the handle 10. The pivoting element 20 includes a lever 21 extending from a head 25. The lever 21 is inserted in the handle 10 so that an end thereof is placed against the strain gauge 15. The lever 21 is pivotally connected to the handle 10 by a pin 11. The selective one-way driving mechanism 30 is placed in the head 25. The elastic element 40 is placed between the handle 10 and the pivoting element 20.

In operation, a nut or screw is placed in a socket that is engaged with the selective one-way driving mechanism 30. Then, the handle 10 is pivoted to and fro to rotate the nut or screw. There is however a time lag between the start of the pivoting of the handle 10 and the start of the rotation of the nut or screw since the handle 10 can be pivoted relative to the pivoting element 20. Because of this time lag, a user inevitably pivots the handle 10 fast and hits the pivoting element 20 hard with the handle 10 before he or she actually pivots the nut or screw. The hitting of the pivoting element 20 with the handle 10 brings about uncomfortable feeling for the user and damages for the parts. Even when the torque-indicating wrench is not in use, the head pivoting element 20 tends to pivot and hit the handle 10, thus causing damages. The elastic element 40, which is made of plastics generally, is intended to reduce the uncomfortable feeling and the damages. However, the elastic element 40 could soon be damaged due to hits or aging.

The present invention is therefore intended to obviate or at least alleviate the problems encountered in prior art.

### SUMMARY OF INVENTION

It is the primary objective of the present invention to provide a robust torque-indicating wrench.

To achieve the foregoing objective, the torque-indicating wrench includes a handle, a strain gauge, a lever, a head and a driving mechanism. The strain gauge is placed in the handle. The lever including a first end inserted in and pivotally connected to the handle and abutted against the strain gauge and a second end placed out of the handle. The head includes a tubular portion non-pivotally placed around and on the handle. The driving mechanism includes a bit-rotating element pivotally placed in the head and formed with a crank pivotally connected to the second end of the lever.

Other objectives, advantages and features of the present invention will be apparent from the following description referring to the attached drawings.

### BRIEF DESCRIPTION OF DRAWINGS

The present invention will be described via detailed illustration of three embodiments versus the prior art referring to the drawings wherein:

FIG. 1 is a cross-sectional view of a conventional torque-indicating wrench;

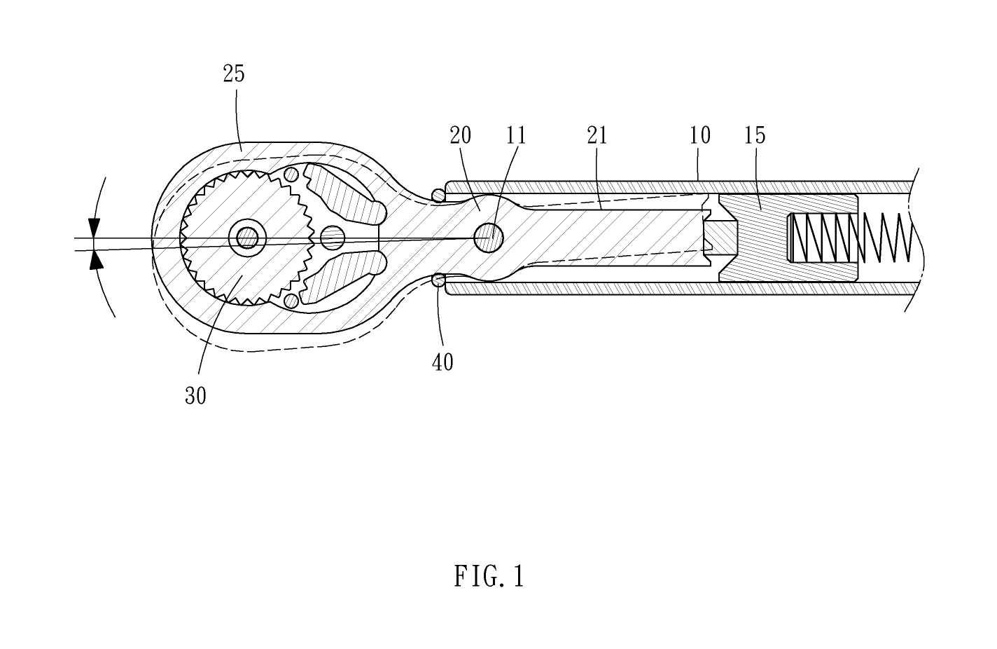

FIG. 2 is a cross-sectional view of the conventional torque-indicating wrench in another position than shown in FIG. 1;

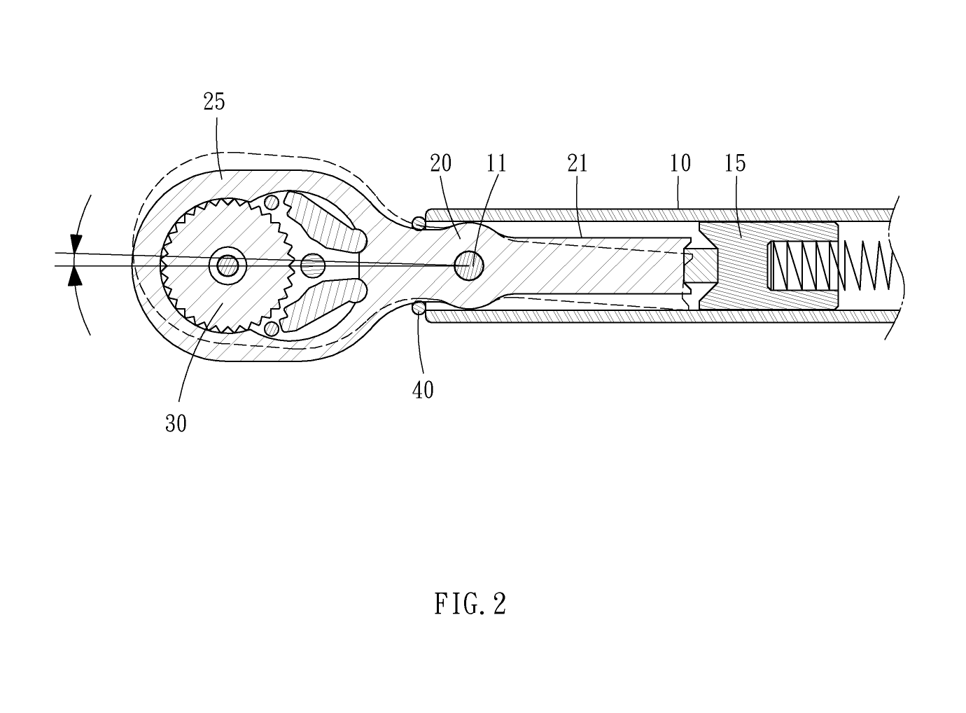

FIG. 3 is an exploded view of a torque-indicating wrench according to the first embodiment of the present invention;

FIG. 4 is a cross-sectional view of the torque-indicating wrench shown in FIG. 3;

FIG. 5 is a cross-sectional view of the torque-indicating wrench in another position than shown in FIG. 4;

FIG. 6 is a cross-sectional view of the torque-indicating wrench in another position than shown in FIG. 5;

FIG. 7 is a cross-sectional view of a torque-indicating wrench according to the second embodiment of the present invention; and

FIG. 8 is a cross-sectional view of a torque-indicating wrench according to the third embodiment of the present invention.

### DETAILED DESCRIPTION OF EMBODIMENTS

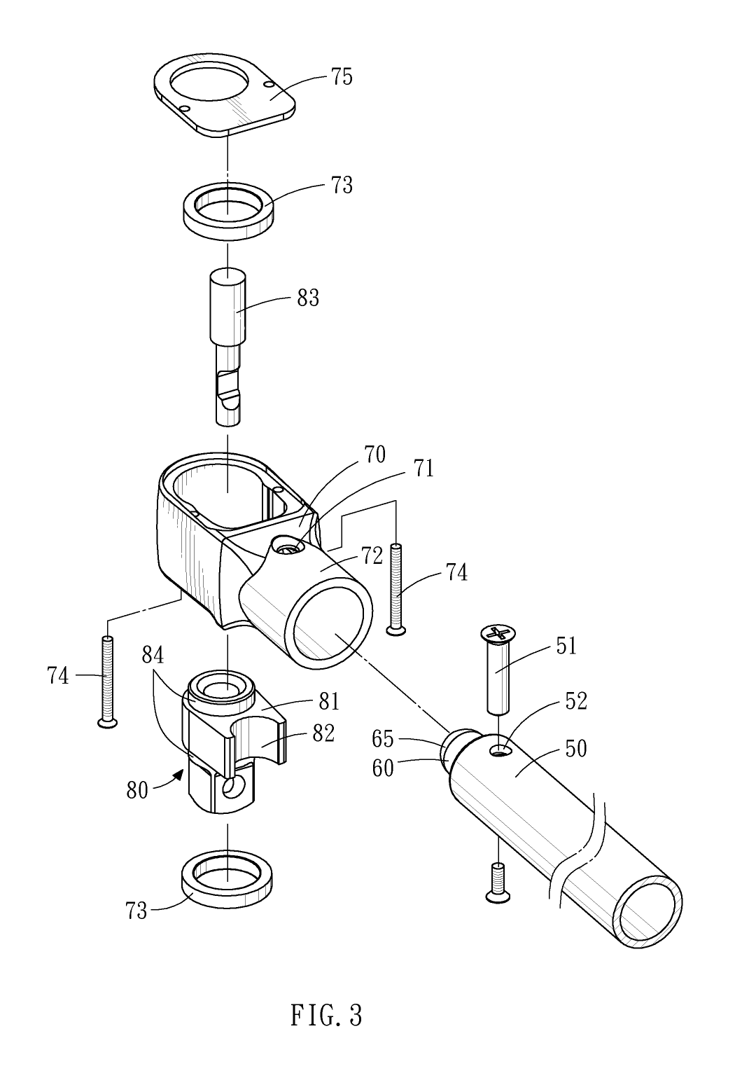

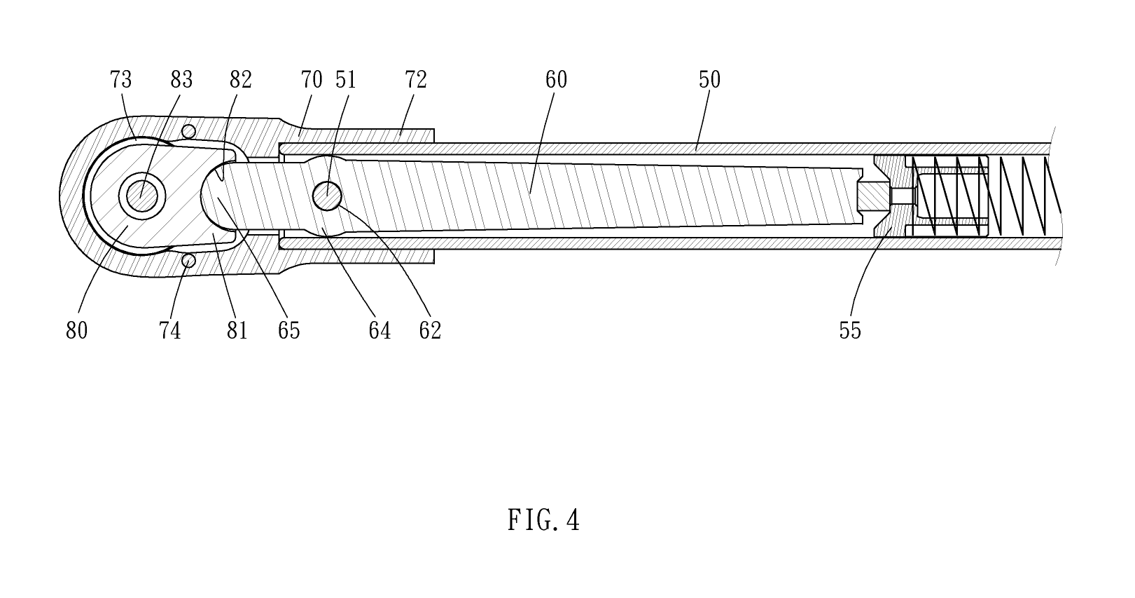

Referring to FIGS. 3 and 4, there is shown a robust torque-indicating wrench according to a first embodiment of the present invention. The robust torque-indicating wrench includes a handle 50, a lever 60, a head 70 and a driving mechanism. The handle 50 includes an aperture 52 defined therein near an end. A strain gauge 55 is placed against a spring inserted in the handle 50.

The lever 60 is substantially inserted in the handle 50 so that a first end thereof is abutted against the strain gauge 55 while a second end 65 thereof is placed out of the handle 50. The second end 65 of the lever 60 is a rounded end. An aperture 62 is defined in a circular enlarged portion 64 of the lever 60. The width of the lever 60 is smaller than an internal width of the handle 50 so that the lever 60 can be pivoted in the handle 50. An external diameter of the circular enlarged portion 64 of the lever 60 is identical to the internal width of the handle 50 so that the circular enlarged portion 64 of the lever 60 is in contact with the interior of the handle 50 so that the pivoting of the lever 60 in the handle 50 is smooth.

The head 70 is formed with a tubular portion 72. An aperture 71 is defined in the tubular portion 72 of the head 70. The tubular portion 72 of the head 70 is placed around the handle 50. An internal width of the tubular portion 72 of the head 70 is identical to an external width of the handle 50 so that the tubular portion 72 of the head 70 cannot be pivoted on the handle 50. A fastener 51 is driven in the aperture 62 through the aperture 52 and further through the aperture 71 to keep the lever 60 in the handle 50 and the head 70 on the handle 50.

The driving mechanism includes a bit-rotating element 80 and a detent-controlling element 83. The bit-rotating element 80 is a cup-shaped element with a crank 81 extending from the periphery transversely. An arched recess 82 is defined in the crank 81. The bit-rotating element 80 further includes two necks 84 between which the crank 81 is placed.

A first end of the detent-controlling element 83 is inserted in the bit-rotating element 80 while a second end of the detent-controlling element 83 is placed out of the bit-rotating element 80. A detent (not shown) is substantially placed in the bit-rotating element 80. The detent includes a first portion in contact with the detent-controlling element 83 and a second portion movable out of the bit-rotating element 80 via an aperture defined in the bit-rotating element 80. The detent is used to keep a bit on the bit-rotating element 80.

The detent-controlling element 83 is placed in the head 70. Each of the necks 84 is inserted through a bushing 73 placed in the head 70 to render the rotation of the detent-controlling element 83 in the head 70 smooth. The detent-controlling element 83 is kept in the head 70 by a cover 75 secured to the head 70 by two screws 74. The detent-controlling element 83 however extends beyond the cover 75.

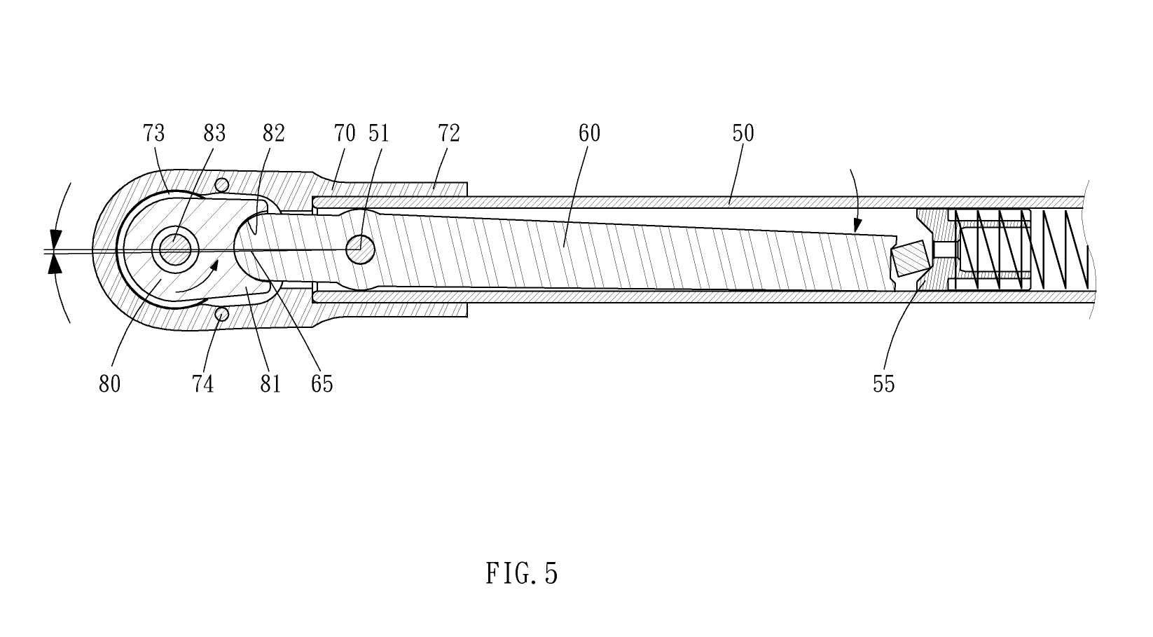

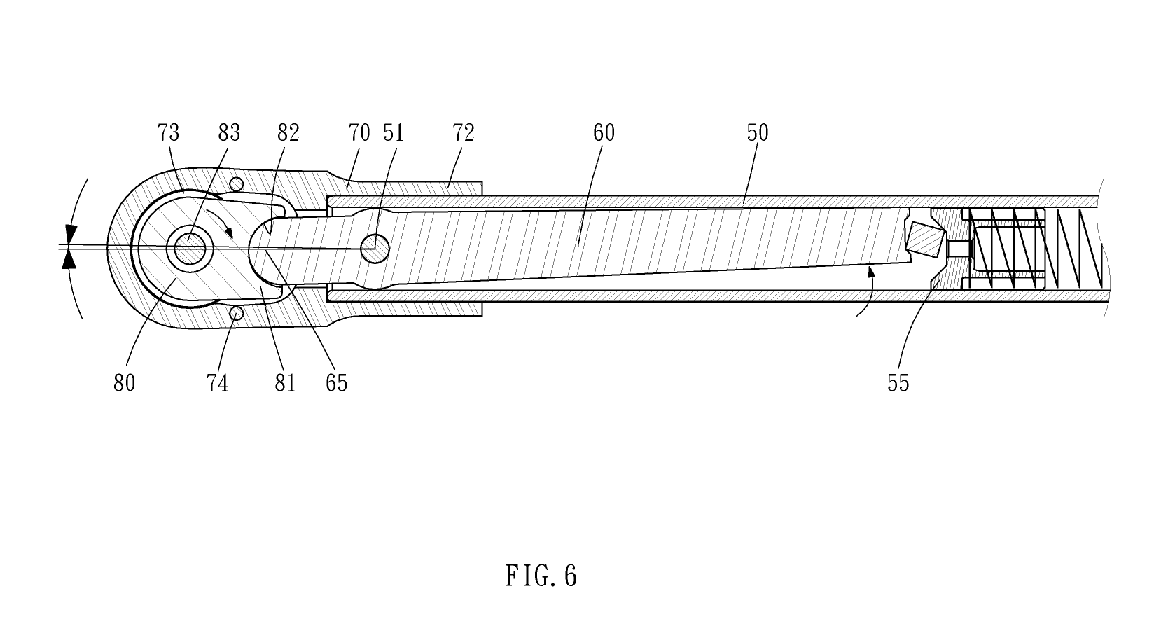

In operation, a nut or screw is placed in a socket that is engaged with the bit-rotating element 80. Then, the handle 50 is pivoted in a direction shown in FIG. 5 or in another direction shown in FIG. 6 to rotate the nut or screw. The handle 50 is protected from the head 70 since the former cannot be pivoted relative to the latter.

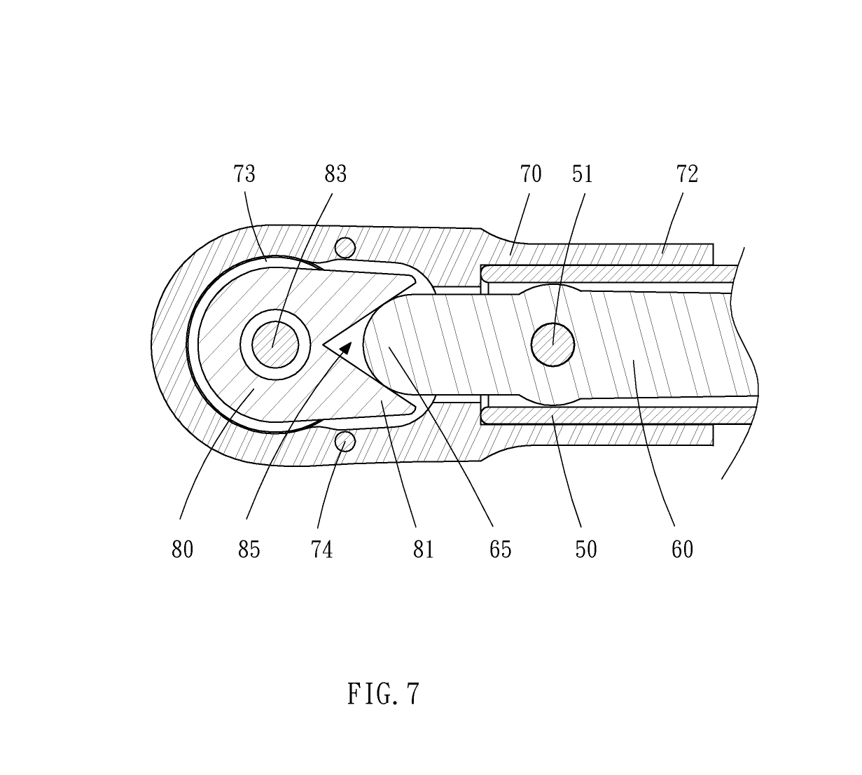

Referring to FIG. 7, there is shown a robust torque-indicating wrench according to a second embodiment of the present invention. The second embodiment is like the first embodiment except that the crank 81 includes a V-shaped recess 85 instead of the arched recess 82.

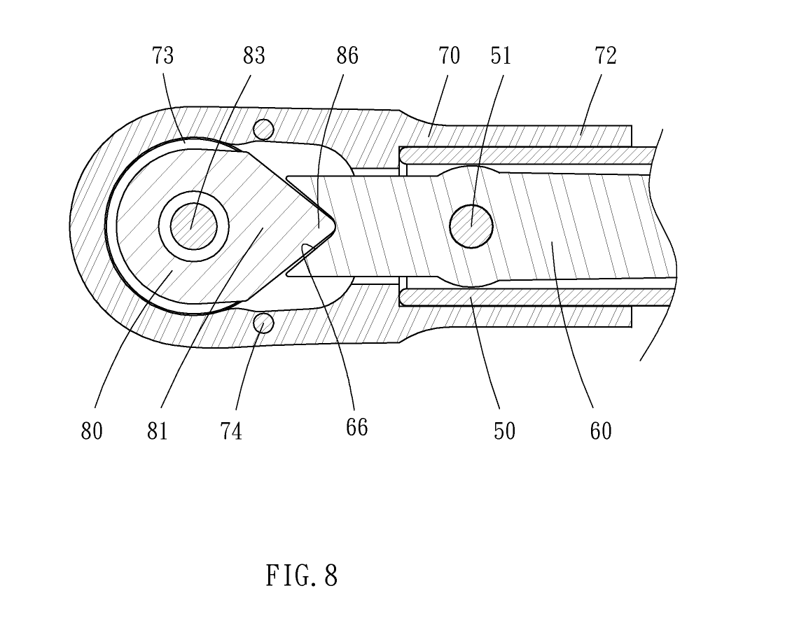

Referring to FIG. 8, there is shown a robust torque-indicating wrench according to a third embodiment of the present invention. The third embodiment is like the first embodiment except that the lever 60 includes a V-shaped recess 66 defined in the second end and that the crank 81 includes a pointed end 86 inserted in the V-shaped recess 66.

Advantageously, the head 70 cannot be pivoted relative to the handle 50. That is, the head 70 does not hit the handle 50 so that they do not damage each other. Therefore, the torque-indicating wrench of the present invention is robust and durable.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A torque-indicating wrench including:
a handle;
a strain gauge placed in the handle;
a lever including a first end inserted in and pivotally connected to the handle and abutted against the strain gauge and a second end placed out of the handle;
a head including a tubular portion non-pivotally placed around and on the handle; and
a driving mechanism including a bit-rotating element pivotally placed in the head and formed with a crank pivotally connected to the second end of the lever.

2. The torque-indicating wrench according to claim 1, wherein the head includes an aperture defined in the tubular portion, wherein the handle includes an aperture defined therein, wherein the lever includes an aperture defined therein, wherein the torque-indicating wrench further includes a fastener inserted in the apertures.

3. The torque-indicating wrench according to claim 1, further including a cover attached to the head by screws for keeping the driving mechanism in the head, wherein the detent-controlling element extends beyond the cover.

4. The torque-indicating wrench according to claim 1, wherein the driving mechanism further includes a detent-controlling element movably inserted in the bit-rotating element and operable to push a detent for engagement with a bit.

5. The torque-indicating wrench according to claim 1, wherein the second end of the lever is a rounded end, wherein the crank includes a recess, for receiving the rounded end of the lever so that the crank is pivotally connected to the lever.

6. The torque-indicating wrench according to claim 8, wherein the recess is an arched recess.

7. The torque-indicating wrench according to claim 1, wherein the recess is a V-shaped recess.

8. The torque-indicating wrench according to claim 1, wherein the lever includes a recess defined in the second end, wherein the crank includes a free end inserted in the recess so that the crank is pivotally connected to the lever.

9. The torque-indicating wrench according to claim 1, wherein the recess is a V-shaped recess, wherein the free end is a pointed end.

10. The torque-indicating wrench according to claim 1, wherein the bit-rotating element includes at least one neck formed thereon, wherein the torque-indicating wrench further includes at least one bushing for supporting the neck.
